(19) United States
(12) Patent Application Publication
(10) Pub. No.: US 2003/0070432 A1
(43) Pub. Date: Apr. 17, 2003

(54) Natural gas depressurization temperature maintenance expansion system with production of useful work

(76) Inventor: Nalin Walpita, Colombo (LK)

Correspondence Address: Eugene E. Renz, Jr., P.C., 205 North Monroe Street, Media, PA, 19063-9056, US

(21) Appl. No.: 10/086,808

(22) Filed: Mar. 4, 2002

Related U.S. Application Data
(60) Provisional application No. 60/273,664, filed on Mar. 5, 2001.

(51) Int. Cl. F01K 25/00; F01B 29/08; F01K 13/00; F02G 1/00; F02C 1/04; F01K 25/02

(52) U.S. Cl. 60/650; 60/516; 60/645

(57) ABSTRACT

The present invention provides a method for depressurizing a gas, comprising at least one cycle of: expanding the gas to a lower pressure and temperature while extracting mechanical energy and converting the mechanical energy to electrical energy; raising the temperature of the gas to ambient temperature through use of heat exchange means; heating the gas with at least some of the energy derived from the step of expanding the gas; whereby the pressure of the gas can be reduced, and the temperature of the gas can be returned near ambient temperature without requiring consumption of chemical energy from the gas. The instant invention also provides a new approach in extracting the potential energy available in the pressure difference between high pressure and low pressure natural gas, while maintaining outlet temperature at reasonable levels.

This application claims priority from U.S. provisional application 60/273,664 filed Mar. 5, 2001.

### FIELD OF THE INVENTION

The invention is in the area of natural gas depressurization wherein useful work may be produced at a depressurization station where hitherto there has been energy loss. The instant invention also relates to a method of using three stages of expansion to generate useful power from natural gas during the gas pressure reduction process. The present invention also provides a method of using ambient heat to provide an inflow of energy at two stages of the expansion of natural gas. Additionally, the invention is also directed to a method of using electrical heat, by recycling a portion of the electrical power output to control the final outgoing gas temperature. The invention also provides a combination of elements consisting of three expanders, two ambient heat exchangers and two electrical heat exchangers to control the outgoing gas temperature while maintaining the temperature at reasonable levels. The method of the invention further enhances the capability to independently control the outgoing gas temperature while producing useful power. The instant invention is further directed to the capability to integrate the mechanical elements so that electrical power is produced by one alternator. The invention also provides compact electrical heaters with high temperature elements to significantly reduce the capital cost.

### DESCRIPTION OF THE PRIOR ART

Natural gas is typically compressed to a high pressure to facilitate transport in the main interstate and intrastate pipeline system. Prior to usage, natural gas has to be depressurized in a location which connects the high pressure pipeline to the distribution system or the user. These depressurization locations are called gate stations. There are over 10,500 gate stations in the contiguous 48 states. The actual depressurization is done through a throttling valve.

Natural gas incoming from the high pressure side to a gate station is generally at the ambient temperature, except in the very special circumstances of being very close to a compressor station where some of the circumstances of being very close to a compressor station where some of the heat of compression would still be available. As such, direction expansion from a typical incoming pressure of 1000 or 600 psig would result in severe overcooling of the gas, down around −124° F. for an expansion from 1000 psig to 150 psig, at an incoming temperature of 32° F.

To prevent very low temperature and hence high condensation and liquefaction in the outgoing circuit, this invention embodies a three stage expansion system with heat input within each expander, between the stages and after the final stage, a portion of the heat requirement will be provided by the ambient or atmospheric heat, with a portion being provided by a feedback of some of the energy output.

By virtue of the interconnected design and the special re-heating methodology, the natural gas temperature is kept high. A quantum of heat is received from the atmosphere, this heat is utilized in expansion and power production. By the very fact that the expanding gas is below ambient temperature, heat may be picked up from the atmosphere. In this way, much more heat is utilized in the expansion than that available from just the refrigeration effect or the energy originally available in the incoming gas. No additional input of heat, e.g. from burning of natural gas is required but if waste heat is available, it may be usefully utilized.

### BACKGROUND OF THE INVENTION

In a number of instances, it has been proposed to preheat the natural gas by consumption of a small quantity of gas and then expand in reciprocating type expanders. In all these cases, some consumption of the gas as a fuel is required, resulting in a reduction of the net quantity of gas flowing to a downstream customer.

Shenoy et al. U.S. Pat. No. 4,677,827 discloses a system whereby a heat pump is used to provide heating after expansion of natural gas. That patent proposes both a heat pump circuit and a thermosiphon based circuit to transfer heat from the atmosphere. The systems proposed are relatively unwieldy in that there are at least two refrigerant circuits and around 8 heat exchangers.

Natural gas is compressed to high pressure for transmission from wells to consumers, typically the pressures in the main interstate pipelines are of the order of 1000-3000 psig. On the other hand, natural gas is distributed to consumers at much lower pressures. Typically, for domestic consumers, the pressure may 20-40 psig and for commercial consumers, 100-150 psig.

The pressure in the interstate high pressure transmission pipeline is reduced to the distribution pressure in a “gate station”, by means of a pressure reducing throttling valve. Several types of throttling valve are to be found, the main types being Direct Operated Valves and Pilot Operated Valves.

The change of pressure between the high pressure transmission pipe and the low pressure distribution side constitutes a loss of potential energy. If the gas is placed within a suitably configured expansion system such energy may be usefully utilized to produce shaft work, which may be converted to electric power. However, there are crucial differences between the expansion and pressure drop in a throttling valve and that in a power generating device. Most crucially, the former is theoretically an isenthalpic or constant enthalpy expansion, typically known as a Jule-Thompson expansion. In such an expansion, depending on the conditions, the outgoing temperature may be lower or higher than the incoming temperature. The governing parameter is known as the Joule Thompson inversion temperature curve. In particular instances where there is significant temperature drop, heating is required to bring the gas temperature back to a reasonable level.

In the case of a direct gas expansion with power generation, where the gas expands in isolation, the theoretical term is isentropic or adiabatic, reversible expansion. External work or energy is extracted from the gas stream, this means the outlet enthalpy of the gas is lower than the inlet enthalpy. Invariably, this means the outlet temperature is lower than at inlet. Because of the substantial pressure difference between the incoming main and distribution main, if a direct expansion is carried out, the result is a very low gas temperature exiting the expander, see FIG. 1 below.

Such low temperatures are unacceptable because a substantial number of the components in the gas will liquefy or solidify. Therefore, a method is required to capture the useful energy in the pressure difference between transmission mains and distribution mains, without substantial temperature decrease. A simple method suggested has been to preheat the incoming gas by burning a portion of the natural gas.

There are a number of limitations connected with preheating natural gas prior to entry to a power generation expander. First, raising the temperature of a flammable substance is undesirable from a safety point of view. Secondly, there is added energy consumption required, which reduces the net amount of gas flowing from the gate or pressure reducing station to the downstream consumer. Thirdly, there is a fuel cost associated with consuming some gas to ensure gas outlet temperature does not drop to unacceptable levels.

With the above background, the present invention embodies natural gas depressurization with associated power generation, whereby no gas is consumed as fuel to maintain outlet temperature of the expanded gas within acceptable levels. Total gas compression in the United States is over 15,000 MW. By recovering around 40%-50% of this amount as useful power, at the points where depressurization is done, there would be substantial benefit both as contribution to electrical energy supply and in offsetting carbon emissions.

The present invention constitutes a new approach in extracting the potential energy available in the pressure difference between high pressure and low pressure natural gas, while maintaining outlet temperature at reasonable levels. Most attempts hitherto have involved using a quantum of gas as a fuel to preheat the natural gas so that the temperature after expansion is kept at a reasonable level, such that there is no occurrence of freezing. Other attempts have looked at using complex heat pump and secondary fluid cycles to maintain the temperature.

### BRIEF DESCRIPTION OF THE FIGURES

FIG. 1 illustrates the correlation of final temperature versus final pressure for direct natural gas expansion.

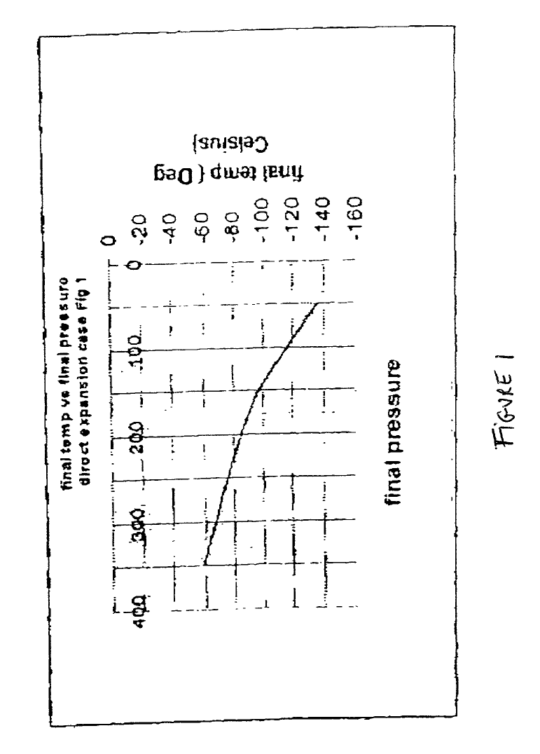

FIG. 2 describes a brief schematic of the invention.

FIG. 3 shows a detailed flow schematic of the invention.

FIG. 4 illustrates an ideal energy balance diagram.

### SUMMARY OF THE INVENTION

The present invention provides a method for depressurizing a gas, comprising at least one cycle of: expanding the gas to a lower pressure and temperature while extracting mechanical energy and converting the mechanical energy to electrical energy; raising the temperature of the gas to ambient temperature through use of heat exchange means; heating the gas with at least some of the energy derived from the step of expanding the gas; whereby the pressure of the gas can be reduced, and the temperature of the gas can be returned near ambient temperature without requiring consumption of chemical energy from the gas.

The instant invention is also directed to a method for depressurizing a gas, comprising multiple cycles of: expanding the gas to a lower pressure and temperature while extracting mechanical energy and converting the mechanical energy to electrical energy; raising the temperature of the gas to ambient temperature through use of heat exchange means; heating the gas with at least some of the energy derived from the step of expanding the gas; whereby the pressure of the gas can be reduced, and the temperature of the gas can be returned near ambient temperature without requiring consumption of chemical energy from the gas, and while limiting the minimum temperature reached by the gas during any of said multiple cycles.

### DESCRIPTION OF THE PREFERRED EMBODIMENT

In order to extract useful work from a gas, either a positive displacement type expansion (i.e. a pressure change) or a change of velocity vector is required. The former occurs in a reciprocating type engine and the latter, in an impulse turbine. In a conventional gas turbine, both impulse and reaction type stages are present, i.e. both changes in velocity vector and changes in pressure take place. In order to produce a velocity from an initially pressurized gas, the gas must be accelerated in an isentropic nozzle. A nozzle converts pressure and thermal energy into velocity energy.

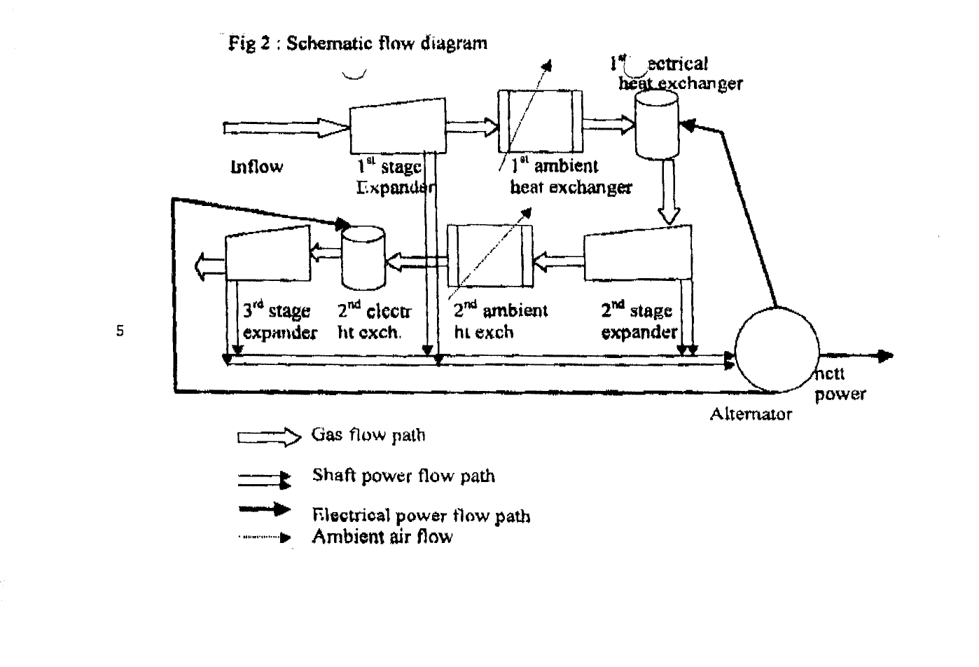

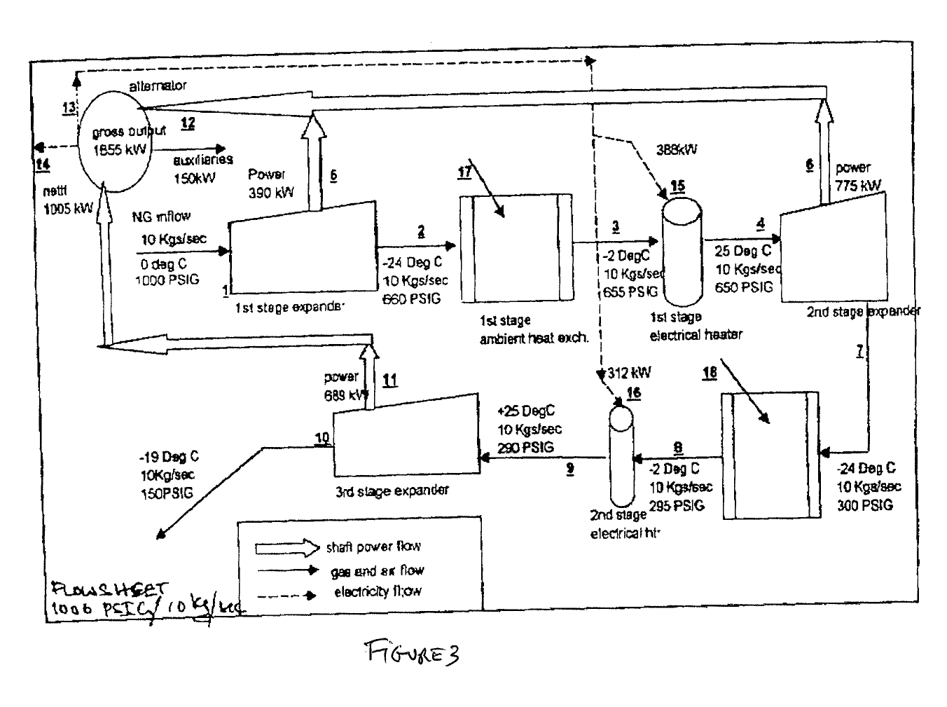

In the case of the expansion of natural gas, the present invention embodies a multi-stage unit with several stages of heat transfer, to mitigate any excessive cooling effects. In FIG. 2, the basic schematic outline of the invention is given, with a detailed flow sheet given in FIG. 3. The system consists of three expanders and four heat exchangers as shown. Natural gas at incoming temperature, which is usually ambient temperature, is passed through the first expander, with a reduction in pressure of around 35% from the incoming value. The work done is converted into shaft work, subsequently used to drive an electrical alternator. Assuming a temperature of 0° Celsius in the incoming stream, the temperature of heavier compounds in the gas stream. After this stage, it is taken to heat exchanger No. 1 and heat addition takes place from the atmosphere. This can be done because there is a significant temperature difference between the gas exiting the 1^{st} stage expander and the atmosphere.

Thereafter, the gas at a lower pressure but at near ambient temperature is passed through a heating element consisting of an electrically heated exchanger, wherein gas in tubes is heated by means fully insulated electrical heating wires placed in the flow. Since the electrical heating element is at very high temperature compared with the gas, a very compact electrical heater configuration can be designed.

The gas temperature is increased to between 10-26° Celsius above ambient, by this measure. Thereafter, the gas is passed into the second stage expander, whereby the gas pressure is reduced 65% from the incoming value. The work done by the gas is further converted into shaft work by this expander.

After the second stage, the gas is taken into another ambient air heat exchanger, whereby the temperature is again brought up to nearly that of the ambient. Thereafter, the gas is taken to another electrically heated heat exchanger, wherein the temperature is once again increased to a level 10-25° Celsius above ambient.

After the second electrically heated heat exchanger, the gas passes through the third and final expander, where the energy changes in the gas is converted to shaft work. The gas exiting the third expander is now at around 16 to 19° Celsius, in a case where the outgoing pressure is 150 psig. It is warmed up to ambient temperature by passing through a convective heat exchanger.

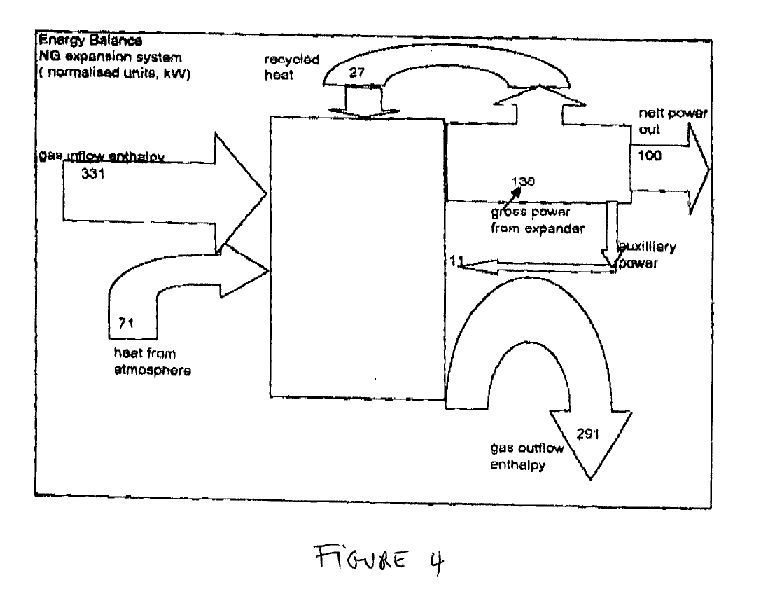

The energy balance diagram for the process is given in FIG. 4. The diagram is on the basis of expanding natural gas from 1000 psig to 150 psig, i.e. a pressure drop of 850 psig, normalized on the basis of 100 units of net output power from the alternator. The ideal case, i.e. no losses from any part of the process, is considered. Because of the low temperature of the natural gas exiting from each expander stage, heat transfer can take place between the atmosphere and the gas. The temperature difference between the atmosphere and the gas is not very high. This means the heat transfer coefficient and transfer surface area must be large, but calculations show that the size is not excessive.

Because of the unique arrangement of expanders and heat exchange elements, the expansion of the gas is not unconstrained but is controlled. The system control philosophy enables us to fully control the degree of heating in the electrical heaters and partially control the heat in the ambient air heaters. In this manner, by increasing the control interventions at each point, the tendency for the temperature to drop below unacceptable limits is avoided.

The control of gas flow through the system is effected by means of a single throttle valve on the inlet to the first expander and by means within each expander to restrict the total flow volume, which is the subject of another patent.

The method by which power is returned to the expansion process from the alternator constitutes an innovation and allows the temperature of the gas to be raised a little above ambient, before entry to the 2^{nd} and 3^{rd} expanders. This power essentially rotates around in the process and has the function of raising the baseline temperature level in the expanding fluid , to prevent freezing. The temperature to which the gas is raised before entry to the 2^{nd} and 3^{rd} expanders is no greater than summer ambient temperature.

In every case where temperature of an expanding gas is below atmospheric temperature, heat may be acquired from the atmosphere. If the temperature difference between the gas and atmosphere is small, then the heat transfer surface area would need to be adjusted upward and significant fan power would be expanded in moving atmospheric air past the outer heat transfer surfaces. Calculations show that the fan power thus required will not exceed 10% of gross power output.

The energy balance diagram gives a net power output of 100 units after accounting for the auxiliary power requirement, which is shown returned independently of the electrical power for heating. This is because auxiliary power is defined as power required mostly for running of pumps, fans and the instrumentation and control system.

Because the surface temperature of electrical heating elements is high and because direct contact of the gas with insulated heating elements is feasible, each electrical heat exchanger is relatively small in size.

The invention therefore embodies a method of obtaining useful power from a natural gas expansion process with complete control of natural gas temperature using also a quantum of atmospheric heat. Using atmospheric heat is facilitates by the expansion of the gas to below atmospheric temperatures within the process.

A further refinement in the system is that a portion of the electrical heat recycled back to the two electrical heaters may be introduced to the expander rotating elements, to prevent any ice buildup.

The system consists of several modular expanders and heat exchange devices configured as given in FIG. 2: the actual configuration, together with flow and other parameters for a typical case, inclusive of the energy losses in the expander and heat exchangers, is given in FIG. 3.

The conditions pertaining to an inflow rate of 10 Kgs/sec at a temperature of 0° C. and 1000 psig line pressure is given in FIG. 3. The incoming gas is introduced into first stage expander i.e. entering at point 1 and leaving at point 2 in the detailed flow diagram (FIG. 3). In this expander, the pressure is reduced from 1000 psig line pressure to 660 psig. The first expander produces an output of 390 kW (point 5). In this first expansion process, the temperature drops to 24° Celsius. The gas flow then enters the 1^{st} stage ambient air heat exchanger, leaving gas condition from this heat exchanger at point 3 is −2° C. and 655 psig. In passing through the ambient air heat exchanger, there is an average temperature difference between the atmosphere (ambient) and the gas of approximately 12° C., which is sufficient to enable heat flow from the atmosphere to the gas.

After passing through the 1^{st} ambient heat exchanger, the gas is then passed through a compact electrical heater, wherein the temperature of the gas is increased. The outlet conditions from this electrical heater (heat exchanger), at 4 are temperature +25° C., pressure 650 psig. The gas then passes through the second expander, shaft work of 775 kW is produced in this unit. The 2^{nd} expander gas leaving conditions are at 7, −24° C. temperature and 300 psig pressure. The gas then enters a second ambient air heat exchanger, wherein again there is heat inflow form the atmosphere by virtue of a temperature difference of around 12° C. The gas leaving conditions from the 2^{nd} stage ambient heat exchanger, the gas enters a 2^{nd} stage electrical heater, wherein 312 kW of heat are added. The leaving conditions from the 2^{nd} stage electrical heater at 9 are +25° C. and 290 psig pressure.

From the second stage electrical heater, the gas enters the third and final expander, such that reduction in pressure to the level required in the outgoing network, 150 psig, takes place. The outgoing temperature from this expander is −19° C.

The elements and interconnections as shown in the flow diagram are applicable are basis to the design. The actual physical values will change depending on gas inflow and ambient conditions.

The invention also embodies independent control of the heat input in the two electrical heaters by which means the inlet gas temperatures to each downstream expander may be varied independently as required. By the same token, each outgoing gas temperature at point 4 and point 9 are independently controllable.

All of the figures given in FIG. 3 are generic and may be varied without any change to the general principles and functioning of the invention.

The invention further embodies the following novel features:

1. A method of using 3 stages of expansion to generate useful power from natural gas during the gas pressure reduction process.

2. A method of using ambient heat to provide an inflow of energy at two stages of the expansion of natural gas.

3. A method of using electrical heat, by recycling a portion of the electrical power output to control the final outgoing gas temperature.

4. A combination of elements consisting of three expanders, two ambient heat exchangers and two electrical heat exchangers to control the outgoing gas temperature while maintaining the temperature at reasonable levels.

5. The capability to independently control the outgoing gas temperature while producing useful power.

6. The capability to integrate the mechanical elements so that electrical power is produced by one alternator.

7. Using compact electrical heaters with high temperature elements to significantly reduce the capital cost.

Additionally, for purposes of natural gas expansion while keeping the temperature of the outgoing gas within manageable limits while extracting energy from stream, the gas is first expanded to a first intermediate pressure which is between 60% to 70% less than the incoming line pressure. The gas is then heated up by means of a first ambient air heat exchanger which transfers heat from the atmosphere to the gas, which enters the first heat exchanger at a temperature significantly below atmosphere. Heat transfer in this first heat exchanger is facilitated by the provision of sufficient heat transfer area and through forced convection of ambient air, to carry out the necessary duty. The gas then passes through a second heat exchanger which is a first electrically heated heat exchanger, where the temperature of the gas stream is heated a little above atmospheric temperature. Only a portion of the final power produced is used for this purpose.

The gas then passes through a second expander wherein shaft work is once again extracted. The gas after the second expander is passed through a third heat exchanger which constitutes the second ambient air heat exchanger. In this third heat exchanger (second ambient air heat exchanger) the gas is once again heated up to hear atmospheric temperature by provision of sufficient heat transfer area and through forced draft of ambient air.

Subsequently, the gas passes through a fourth heat exchanger which is a second electrically heated heat exchanger, wherein electrical energy as only a portion of the main output is supplied to heat the gas a little above atmospheric temperature. The gas is then passed through a third and last expander wherein shaft work is extracted. The gas then passes out into the distribution network. By virtue of heat transfer from the atmosphere, the gas expansion system is not isolated but communicates with and receives heat from the external environment. In this manner, the shaft work done is a combination of the gas enthalpy change due to the drop in temperature and pressure, plus the heat received from the environment. The electrical heat input to the gas after the 1^{st} and 2^{nd} expanders merely circulates around within the process and is instrumental in keeping a high baseline for the average temperature within the process. The energy balance for the process is given in Table 1. It is to be noted the energy balance of Table 1 is for a real process with a component efficiency of 81.5%.

TABLE 1*
Energy Balance Table 81.5% isentropic efficiency

| Input Table | Output Table |
|---|---|
| Incoming Enthalpy - 534 | Outgoing Enthalpy - 497 |
| Electrical Work recycled - 72 | Gross work out - 191 |
| Ambient Heat Added - 97 | Work Loss - 15 |
| Totals = 704 | Totals = 704 |
| | Gross work out - 191 |
| | Electrical work returned - 72 |
| | Auxiliary power - 19 |
| | Net work out - 100 |

*Units are normalized to useful work output of 100 kW.

The invention further embodies a control system wherein the quantum of heat recycled or put back from the electrical energy output is wholly controllable depending on the temperature requirements within the stages and at outlet.

A practical system for natural gas depressurization would have associated losses, hence any evaluation of the energy balance must take this into account. A typical energy balance for a practical system with losses is given below.

By virtue of addition of ambient heat to a gas which is expanding below atmospheric temperature, it is possible to produce useful work while maintaining the outgoing gas at a reasonable temperature. The heat exchanger sizing calculation shows that two heat exchangers with externally finning will provide the necessary heat transfer with a log mean temperature difference of around 8° Celsius.

Even though particular embodiments of the present invention have been illustrated and described herein, it is not intended to limit the invention. Thus, the present invention is well adapted to carry out the objects and attain the ends and advantages mentioned as well as those which are inherent therein. While numerous changes may be made by those skilled in the art, such changes are encompassed within the spirit of this invention as defined by the appended claims.

What is claimed is:

1. A method for depressurizing a gas, comprising at least one cycle of: expanding the gas to a lower pressure and temperature while extracting mechanical energy and converting the mechanical energy to electrical energy; raising the temperature of the gas to ambient temperature through use of heat exchange means; heating the gas with at least some of the energy derived from the step of expanding the gas; whereby the pressure of the gas can be reduced, and the temperature of the gas can be returned near ambient temperature without requiring consumption of chemical energy from the gas.

2. The method of claim 1 for depressurizing a gas, wherein multiple cycles of expanding the gas, raising the temperature of the gas through heat exchange means, and heating the gas using energy derived in the step of expanding the gas are performed, in order to limit the minimum temperature reached by the gas during any of said multiple cycles.

3. The method of claim 1 for depressurizing a gas, wherein said gas is natural gas.

4. A method for depressurizing a gas, comprising multiple cycles of: expanding the gas to a lower pressure and temperature while extracting mechanical energy and converting the mechanical energy to electrical energy; raising the temperature of the gas to ambient temperature through use of heat exchange means; heating the gas with at least some of the energy derived from the step of expanding the gas; whereby the pressure of the gas can be reduced, and the temperature of the gas can be returned near ambient temperature without requiring consumption of chemical energy from the gas, and while limiting the minimum temperature reached by the gas during any of said multiple cycles.

5. The method of claim 4 for depressurizing a gas, wherein said gas is natural gas.
